(19) United States
(12) Patent Application Publication
(10) Pub. No.: US 2009/0315542 A1
(43) Pub. Date: Dec. 24, 2009

(54) Pole Position Measuring Device for a Magnetic Levitation Vehicle on a Magnetic Levitation Track and Method for Operation Thereof

(75) Inventor: Robert Schmid, Neunkirchen am Brand (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/520,566

(22) PCT Filed: Dec. 14, 2007
(86) PCT No.: PCT/EP07/63999

§ 371 Date: Sep. 10, 2009

(30) Foreign Application Priority Data
Dec. 21, 2006 (DE) 10 2006 061 928.5

(51) Int. Cl. G01B 7/14

(52) U.S. Cl. 324/207.11

(57) ABSTRACT

A pole position measuring device for a magnetic levitation vehicle on a magnetic levitation track has a magnetic field sensor pair, for measuring the stator magnetic field of a track side stator, both magnetic field sensors of the magnetic field sensor pair being arranged at a given separation from each other and an evaluation device, which determines the pole orientation angle between the stator magnetic field of the track side stator and the magnetic reference axis of the magnetic levitation vehicle by means of the measured values from both magnetic field sensors. The separation between the two magnetic field sensors is less than half the wavelength of the fundamental wave of the track side stator magnetic field and the evaluation device is configured to determine the pole orientation angle from the measured values of the magnetic field sensors arranged thus.

The invention relates to a pole orientation measurement device for a magnetic levitation vehicle of a magnetic levitation railroad having the features as claimed in the precharacterizing clause of claim 1.

Pole orientation measurement devices such as these for magnetic levitation vehicles are in use, for example, for Transrapid. The pole orientation measurement devices are fitted at the front and rear, to be precise on both vehicle sides—that is to say on the left and right seen in the direction of travel—and are each equipped with a pair of magnetic field sensors for measurement of the stator magnetic field of the trackside stator of the magnetic railroad track. The position and method of operation of the pairs of sensors will be described in the following text with reference to the front, right-hand pair of sensors, by way of example; however, the explanations apply analogously to the other pairs of sensors. The magnetic field sensors of the front right-hand pair of magnetic field sensors are each attached in their own right to a mount, on which the front right-hand supporting magnet of the magnetic levitation vehicle is also mounted. The distance between the two magnetic field sensors is τ/2, that is to say specifically 129 mm, where τ is the wavelength of the fundamental of the trackside stator magnetic field, and is 258 mm. An evaluation device is connected to the two magnetic field sensors of the pair of magnetic field sensors and determines the pole orientation angle between the stator magnetic field of the trackside stator and the magnetic reference axis of the magnetic levitation vehicle by means of the measured values from the two magnetic field sensors. In the case of Transrapid type magnetic levitation vehicles, an active measurement coil for production of a magnetic field is also located between the pole orientation measurement device and the adjacent supporting magnet; a detection device is connected to this measurement coil and is used to determine whether a stator slot or a stator tooth of the trackside stator is located in the immediate vicinity of the measurement coil. The detection device carries out an incremental position measurement by counting down stator slots and/or stator teeth. The measurement coil and the detection device are located in a housing which—seen in the vehicle longitudinal direction—has a length of 120 mm and is arranged between the supporting magnet and the pole orientation measurement device.

Against the background of a pole orientation measurement device of the type described, the invention is based on the object of developing this device further such that space is saved. According to the invention, this object is achieved by the characterizing features of claim 1. Advantageous refinements of the invention are specified in the dependent claims.

The invention accordingly provides that the distance between the two magnetic field sensors is less than half the wavelength of the fundamental of the trackside stator magnetic field, and that the evaluation device is designed such that it determines the pole orientation angle by means of the measured values of the magnetic field sensors arranged in this way.

One major advantage of the invention is that space is provided for other applications by the denser arrangement of the magnetic field sensors than in the past; if no other applications are desired, then the space that has been made free can alternatively be used, for example, to shorten the front area or rear area of the magnetic levitation vehicle.

A further major advantage of the invention is that the denser arrangement of the magnetic field sensors makes it possible for these to be positioned differently than in the past on the magnetic levitation vehicle; for example, it is possible to accommodate them within the housing that has already been mentioned in the introduction, in which the measurement coil and the detection device for the incremental position measurement are located in Transrapid. Until now, a position such as this has not been possible in Transrapid, because the distance between the magnetic field sensors is greater than the housing size.

The evaluation device can form the pole orientation angle in a particularly simple and therefore advantageous manner in that it determines auxiliary measured values by means of the measured values from the two magnetic field sensors, which auxiliary measured values correspond to measured values as would occur if the magnetic field sensors were to be arranged separated by half the wavelength of the fundamental of the trackside stator magnetic field, and in that it determines the pole orientation angle by means of the auxiliary measured values formed in this way.

With regard to simple and cost-effective fitting, it is considered to be advantageous for the two magnetic field sensors to be arranged in a common housing, and for the housing to be mounted in or on the rail vehicle. For example, the housing is attached to a mount which is also fitted with at least one supporting magnet of the magnetic levitation vehicle.

Since the distance between the two magnetic field sensors corresponds to half the wavelength of the fundamental of the trackside stator magnetic field minus a difference distance, it is considered to be advantageous for the evaluation device to be designed such that it determines the pole orientation angle by means of a correction angle which takes account of the difference distance value, and by means of the measured values of the two magnetic field sensors.

By way of example, the evaluation device has an input connection at which a distance value, which indicates the distance between the two magnetic field sensors, or the difference distance value can be entered; in this case, the evaluation device is preferably designed such that it determines the correction angle from the distance value or the difference distance value and the wavelength of the fundamental of the trackside stator.

Alternatively, the evaluation device may have an input connection at which the correction value can be entered directly, that is to say as such; this refinement avoids the need for computational determination of the correction angle within the evaluation device, or by it.

The evaluation device can determine an auxiliary pole orientation angle in a particularly simple and therefore advantageous manner by means of the auxiliary measured values, as follows:

γ1=atan 2(H1/H2)

where γ1 is the auxiliary pole orientation angle and H1 and H2 are the auxiliary measured values. The sought pole orientation angle γ is then calculated by means of the auxiliary pole orientation angle γ1. As is known, the function atan 2 in this case means the reciprocal function of the angle function tangent, for which, in addition to the quotient tan(x)=sin (x)/cos(x) a validity range from −π to +π, that is to say one complete cycle of the sought angle γ1, is achieved by taking account of the mathematical sign of the Numerator; in contrast, the function atan(x) is defined only in the range −π/2 to +π/2.

The auxiliary measured values are preferably determined by the evaluation device by using the measured values from the two magnetic field sensors, as follows:

$$H 1 = \frac{Sm \cdot cos ( β )}{{cos}^{2} ( β ) - {sin}^{2} ( β )} - \frac{Cm \cdot sin ( β )}{{cos}^{2} ( β ) - {sin}^{2} ( β )}$$

$$H 2 = \frac{Cm \cdot cos ( β )}{{cos}^{2} ( β ) - {sin}^{2} ( β )} - \frac{Sm \cdot sin ( β )}{{cos}^{2} ( β ) - {sin}^{2} ( β )}$$

where Sm and Cm are the measured values from the two measurement sensors, and β is the correction angle already mentioned.

By way of example, the evaluation device determines the correction angle as follows:

$$β = \frac{\frac{τ}{2} - A}{τ} \cdot \frac{π}{2}$$

where A is the distance and τ the wavelength of the fundamental of the trackside stator magnetic field.

In order to save a particularly large amount of space, it is considered to be advantageous for the measurement coil, which has already been mentioned in conjunction with Transrapid, for the incremental position measurement to be arranged between the two magnetic field sensors of the pair of sensors. The resultant arrangement is preferably accommodated in the same housing.

The invention also relates to a method for the measurement of the pole orientation angle between the magnetic field of a trackside stator of a magnetic levitation railroad track and the magnetic reference axis of a magnetic levitation vehicle which is located on the magnetic levitation railroad track, with the magnetic field of the trackside stator being measured by means of a pair of magnetic field sensors and the pole orientation angle being determined by means of the measured values from the two magnetic field sensors.

This aspect of the invention is based on the object of specifying a method which can be carried out with as little space requirement as possible.

According to the invention, this object is achieved in that the pole orientation angle is determined by means of measured values from magnetic field sensors, the distance between which is less than half the wavelength of the fundamental of the trackside stator magnetic field.

With regard to the advantages of the method according to the invention and with regard to advantageous refinements of the method according to the invention, reference should be made to the above statements in conjunction with the pole orientation measurement device according to the invention.

The invention will be explained in more detail in the following text with reference to exemplary embodiments; in this case, by way of example:

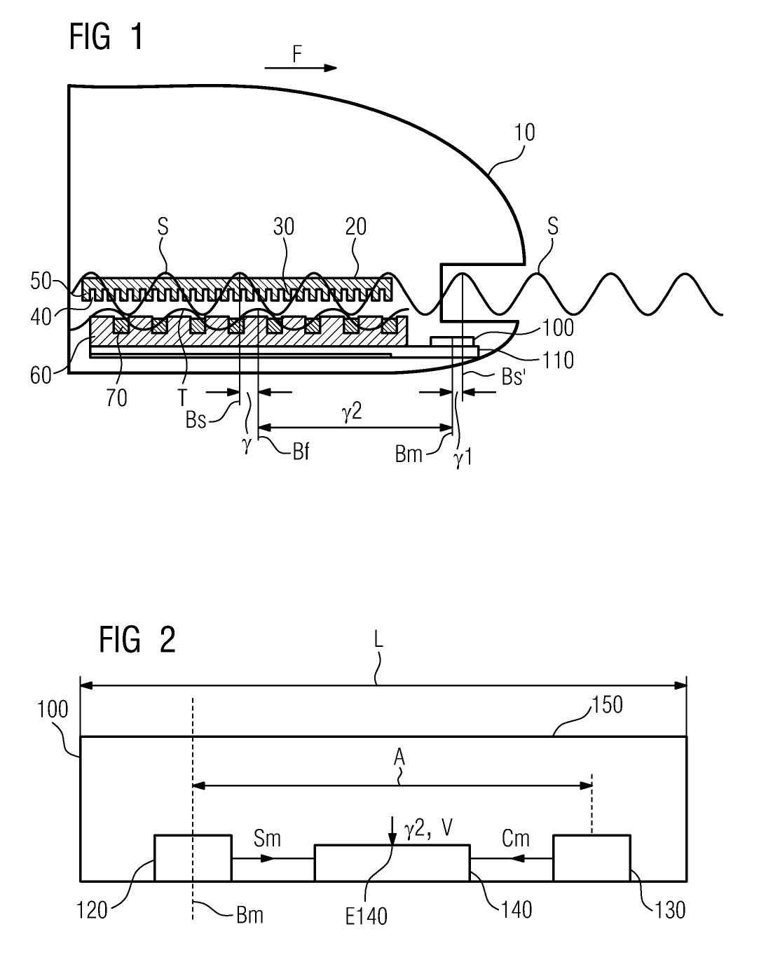

FIG. 1 shows a magnetic levitation vehicle with one exemplary embodiment of a pole orientation measurement device according to the invention,

FIG. 2 shows the pole orientation measurement device as shown in FIG. 1, illustrated enlarged,

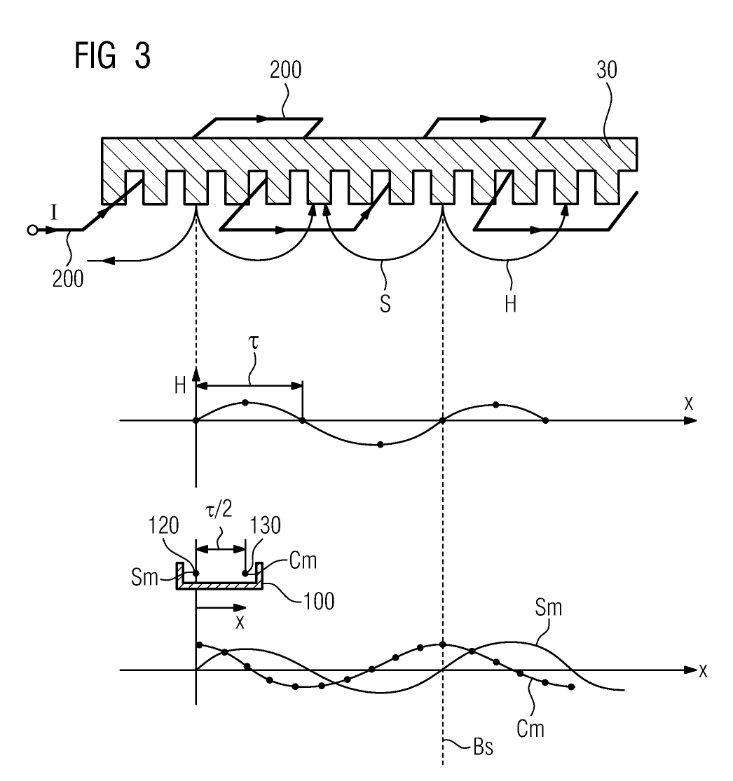

FIG. 3 shows measured value profiles in order to explain the method of operation of the pole orientation measurement device as shown in FIG. 2, for the case of a sensor arrangement at a distance of τ/2,

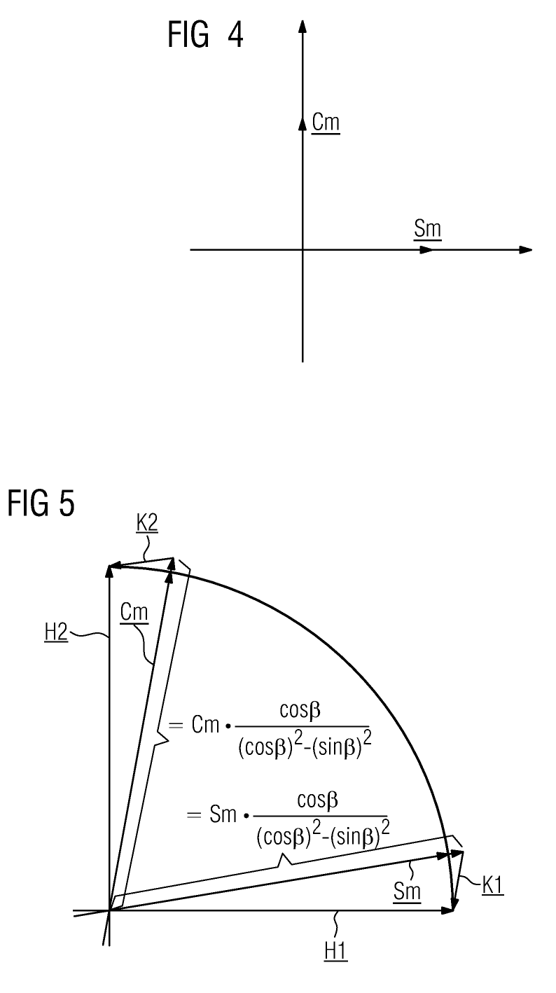

FIG. 4 shows complex measurement vectors from the measured value profiles as shown in FIG. 3,

FIG. 5 shows measurement vectors for the case in which the distance between the magnetic field sensors is less than τ/2, and

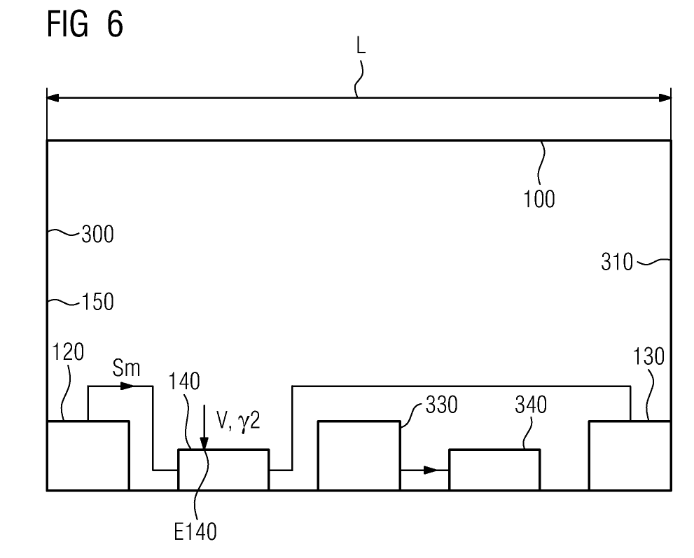

FIG. 6 shows a further exemplary embodiment of a pole orientation measurement device according to the invention.

For clarity reasons, the same reference symbols are used for identical or comparable components in FIGS. 1 to 6.

FIG. 1 shows the front area of a magnetic levitation vehicle 10 which is located on a magnetic levitation railroad track 20. On the magnetic levitation railroad track, FIG. 1 shows a trackside stator 30 which is equipped with stator slots 40 and stator teeth 50.

Magnet coils, which are not illustrated any further in FIG. 1, are located in the stator slots 40, in order to produce a stator magnetic field. The fundamental of the stator magnetic field is annotated with the reference symbol S in FIG. 1. The arrangement and the orientation of the magnet coils define a magnetic reference axis, Bs of the stator 30.

In addition, FIG. 1 shows a front supporting magnet 60 of the magnet levitation vehicle 10; this is equipped with magnet coils 70, which produce a supporting magnetic field in order to lift the magnetic levitation vehicle 10. The supporting magnetic field is annotated by the reference symbol T in FIG. 1. The arrangement and the orientation of the supporting magnets 60 define a magnetic reference axis Bf of the magnetic levitation vehicle 10.

A pole orientation measurement device 100 is fitted in front of the supporting magnet 60 in the direction of travel F; the purpose of the pole orientation measurement device 100 is to determine the pole orientation angle γ between the magnetic reference axis Bs of the stator and the magnetic reference axis Bf of the magnetic levitation vehicle 10.

In the same way as the supporting magnet 60, the pole orientation measurement device 100 is mounted on a common mount 110 in the magnetic levitation vehicle 10.

An exemplary embodiment of the pole orientation measurement device 100 as shown in FIG. 1 is illustrated, enlarged, in more detail in FIG. 2. The pole orientation measurement device 100 has a pair of magnetic field sensors for the measurement of the stator magnetic field S of the trackside stator 30 (cf. FIG. 1); the two magnetic field sensors 120 and 130 of the pair of magnetic field sensors are arranged at a predetermined distance A from one another. One of the two magnetic field sensors 120 or 130, in this case by way of example the magnetic field sensor 120, forms a measurement reference axis Bm of the pole orientation measurement device 100.

In addition, the pole orientation measurement device 100 has an evaluation device 140, which is connected to the two magnetic field sensors 120 or 130 and the purpose of which is to determine, for example to calculate, the pole orientation angle γ by means of the measured values Sm and Cm of the magnetic field sensors 120 and 130.

The distance A between the two magnetic field sensors 120 and 130 is preferably less than 120 mm, which means that the two magnetic field sensors 120 and 130 can be accommodated with the evaluation device 140 in a housing 150 with a length L—seen in the direction of travel—of 120 mm.

The evaluation device 140 uses the measured values Sm and Cm from the two magnetic field sensors 120 and 130 to determine the pole orientation angle γ. For this purpose, it first of all measures an auxiliary pole orientation angle γ1 between the measurement reference axis Bm of the pole orientation measurement device 100 and an auxiliary reference axis BS′, which is offset by a multiple of 2π with respect to the magnetic reference axis Bs of the stator 30 (cf. FIG. 1).

It adds to the auxiliary pole orientation angle γ1 an offset angle γ2, which indicates the phase-angle offset between the magnetic reference axis Bf of the magnetic levitation vehicle 10 and the measurement reference axis Bm of the pole orientation measurement device 100. Integer multiples of 2π contained in the sum value γ1+γ2 are then subtracted from this resultant sum value γ1+γ2, thus forming the sought pole orientation angle γ. Mathematically speaking, the equation for calculation of the pole orientation angle γ is therefore:

γ=(γ1+γ2)modulo(2*π)

The offset angle γ2, which indicates the phase-angle offset between the magnetic reference axis Bf of the magnetic levitation vehicle 10 and the measurement reference axis Bm of the pole orientation measurement device 100, is determined as a function of the mechanical offset V as follows:

γ2=V/τ*π

where τ is the wavelength of the fundamental of the stator magnetic field and, for example, is 258 mm.

The offset angle γ2 is predetermined in a fixed manner, for example, for the evaluation device 140, and is stored in the evaluation device 140. Alternatively, the offset V can also be predetermined in a fixed manner for the evaluation device 140 and stored therein; in this case, the evaluation device 140 itself calculates the offset angle γ2 using the stated formula. The evaluation device 140 has an input connection E140 for inputting the offset V or the offset angle γ2.

In order to explain how the evaluation device 140 can use measured values Sm and Cm to form the auxiliary pole orientation angle γ1, FIGS. 3 and 4 will first of all be used in the following text to explain how this can be done using a sensor separation A=τ/2, as is normal in the prior art. Based on this, an explanation will then be provided, with reference to FIG. 5 by way of example, of how the procedure may appear for a shorter distance A than τ/2.

The upper part of FIG. 3 shows the trackside stator 30; by way of example, a line 200 is shown, which is associated with the conductor coils arranged in the stator 30. The field profile of the magnetic field strength H of the stator magnetic field S is also shown.

The central section of FIG. 3 shows the profile of the amplitude of the magnetic field strength H in the vehicle longitudinal direction x. As can be seen, the field strength has a sinusoidal profile.

The lower section of FIG. 3 shows a sketch of the pole orientation measurement device 100 with the two magnetic field sensors 120 or 130; the distance A is in this case τ/2, as a result of which the two magnetic field sensors produce mutually orthogonal measurement signals. By way of example, it will now be assumed that the magnetic field sensor 120 on the left in FIG. 3 produces measured values Sm on the sine track, and that the magnetic field sensor 130 on the right in FIG. 3 produces measured values Cm on the cosine track; this means that the magnetic field sensor 120 produces a sinusoidal profile as the measurement signal when it is moved forward in the direction of travel starting from the point x=0, and that the magnetic field sensor 130 produces a cosine profile as the measurement signal when it is moved forward in the direction of travel starting from the point x=0. The auxiliary pole orientation angle γ1 changes in a corresponding manner relative to the reference axis Bs with a movement in the x direction.

In this case, mathematically, the measured value profiles are:

$$Sm ( x ) = B 0 \cdot sin ( \frac{x}{τ} \cdot 2 π ) = B 0 \cdot sin ( γ 1 )$$

$$Cm ( x ) = B 0 \cdot cos ( \frac{x}{τ} \cdot 1 π ) = B 0 \cdot cos ( γ 1 )$$

where B0 is the signal amplitude of the magnetic field, which is approximately the same for both magnetic field sensors.

The auxiliary pole orientation angle γ1 can therefore be determined as follows:

$$\frac{Sm ( x )}{Cm ( x )} = \frac{B 0 \cdot sin ( γ 1 )}{B 0 \cdot cos ( γ 1 )} \\ ⇒ γ 1 = a tan 2 [ \frac{Sm ( x )}{Cm ( x )} ]$$

As a further illustration, FIG. 4 also shows the associated vector representation of the measured values Sm and Cm. As can be seen, the two vectors Sm and Cm are mutually perpendicular.

The following text explains how the evaluation device 140 can determine the auxiliary pole orientation angle γ1 when the distance A between the two magnetic field sensors 120 and 130 is not precisely τ/2 but, instead of this, is smaller by a difference distance D. Thus:

A=τ/2−D

The difference distance D results in a change in the measurement vectors Sm and Cm, as can be seen in FIG. 5. As can be seen, the vectors are rotated with respect to one another and are no longer mutually perpendicular. It is therefore now no longer possible to determine the auxiliary pole orientation angle γ1, as in the perpendicular case, as follows:

$$γ 1 = a tan 2 [ \frac{Sm ( x )}{Cm ( x )} ]$$

In order nevertheless to make it possible to determine the auxiliary pole orientation angle γ1 by means of the measured values Sm and Cm, auxiliary measured values H1 and H2 are first of all formed by means of these measured values:

$$H 1 = \frac{Sm \cdot cos ( β )}{{cos}^{2} ( β ) - {sin}^{2} ( β )} - \frac{Cm \cdot sin ( β )}{{cos}^{2} ( β ) - {sin}^{2} ( β )}$$

$$H 2 = \frac{Cm \cdot cos ( β )}{{cos}^{2} ( β ) - {sin}^{2} ( β )} - \frac{Sm \cdot sin ( β )}{{cos}^{2} ( β ) - {sin}^{2} ( β )}$$

where Sm and Cm are the measured values from the two measurement sensors, and β is a correction angle. The two equations for H1 and H2 can be derived mathematically using the addition theorems for trigonometric functions.

The correction angle β describes the difference between the distance A and the “nominal distance” τ/2. The correction angle β can be determined from the difference distance D as follows:

$$β = \frac{D}{τ} \cdot \frac{π}{2}$$

Alternatively, the correction angle β can be calculated by means of the distance A and τ as follows:

$$β = \frac{\frac{τ}{2} - A}{τ} \cdot \frac{π}{2}$$

The sought auxiliary pole orientation angle γ1 can then be determined by means of the auxiliary measured values H1 and H2, as in the case of mutually perpendicular measurement vectors, as follows:

γ1=atan 2(H1/H2)

As can be seen, the auxiliary measured values H1 and H2 correspond to measured values as would be obtained if the two magnetic field sensors were at a distance of τ/2.

This relationship is likewise illustrated in FIG. 5. The figure shows the measured value vectors Sm and Cm, which are not mutually perpendicular, as well as the auxiliary vectors H1 and H2 thus determined. The magnitudes and angles of the measured value vectors Sm and Cm must be corrected in order to obtain the mutually perpendicular auxiliary vectors H1 and H2. As can be seen, this is done by means of a “vector extension” by the factor

$$\frac{cos ( β )}{{cos}^{2} ( β ) - {sin}^{2} ( β )}$$

and by addition of a correction vector K1 and K2, where K2 and Sm as well as K1 and Cm are collinear and parallel.

FIG. 6 shows a further exemplary embodiment of a pole orientation measurement device 100, in detail. This shows the two magnetic field sensors 120 and 130, which are arranged on the two outer edges 300 and 310 of the housing 150. Seen in the direction of travel, the length L of the housing is, for example, 120 mm, which means that the distance A between the magnetic field sensors 120 and 130 is therefore less than τ/2.

The evaluation device 140 is connected to the two magnetic field sensors 120 and 130 and, for example, is formed by a programmable microprocessor device. This device preferably has a corresponding input connection E140 for inputting the offset V or the offset angle γ2.

As can also be seen in FIG. 6, an active measurement coil 330 for production of a magnetic field is arranged between the two magnetic field sensors 120 and 130, preferably centrally between them. The active measurement coil 330 is operated at a relatively high frequency of several MHz, which is well above the frequency of the stator magnetic field S.

The measurement coil 330 is connected to a detection device 340 which is used to determine whether a stator slot 40 or a stator tooth 50 of the stator 30 is located in the immediate vicinity of the measurement coil (cf. FIG. 1). The detection device 340 carries out an incremental position measurement by counting down stator slots and/or stator teeth.

By way of example, an electrical circuit which together with the measurement coil 330 forms an electrical resonant circuit is provided in the detection device 340, for the incremental position measurement. In this case, an oscillating voltage which is characteristic of the resonant circuit is applied to the measurement coil 330. As soon as the inductance of the measurement coil 330 is changed by a change in the magnetic field produced by the measurement coil, then the resonant frequency of the resonant circuit will also change: for example, if the measurement coil 330 is moved into the area of a stator tooth 50 of the stator 30, then its inductance will change, and the resonant frequency will therefore be shifted, because of the additional iron material in the area of the measurement coil 330. Furthermore, eddy current losses occur in the additional iron of the stator 30, as a result of which the resonant circuit is not only detuned, but is also damped. The corresponding change in the resonant frequency of the resonant circuit as well as the change in the amplitude of the voltage on the measure coil 330 can now be measured and evaluated in order to identify the occurrence of stator teeth 50 or stator slots 40. Position-finding can now be carried out by counting down the stator teeth 50 or the stator slots 40 which the vehicle 10 travels past.

In order to prevent the stator magnetic field S from being corrupted by the pole orientation measurement device 100, this device, that is to say the housing 150 and the entire housing interior, is preferably free of iron.

### LIST OF REFERENCE SYMBOLS

10 Magnetic levitation vehicle
20 Magnetic levitation railroad track
30 Trackside stator
40 Stator slots
50 Stator teeth
60 Supporting magnet
70 Magnet coils
100 Pole orientation measurement device
110 Mount
120, 130 Magnetic field sensors
140 Evaluation device
E140 Input connection
150 Housing
200 Line
330 Active measurement coil
340 Detection device
A Distance
Bm Magnetic reference axis of the pole orientation measurement device
Bs Magnetic reference axis of the stator
BS′ Auxiliary reference axis
Bf Magnetic reference axis of the magnetic levitation vehicle
D Difference distance
H Magnetic field strength
S Fundamental of the stator magnetic field
T Supporting magnetic field
V offset
Sm, Cm Measured values
Sm, Cm vectors
β Correction angle
γ Pole orientation angle
γ2 Offset angle
γ1 Auxiliary pole orientation angle
K19, K2 Correction vectors

1-17. (canceled)

18. A pole orientation measurement device for a magnetic levitation vehicle of a magnetic levitation railroad, comprising:
a pair of magnetic field sensors for measurement of a stator magnetic field of a trackside stator, said magnetic field sensors of said pair of magnetic field sensors being disposed at a predetermined distance from one another, said distance being less than half a wavelength of a fundamental of the trackside stator magnetic field; and
an evaluation device connected to receive measured values from said magnetic field sensors and configured to determine a pole orientation angle between the stator magnetic field of the trackside stator and a magnetic reference axis of the magnetic levitation vehicle by way of the measured values received from said magnetic field sensors.

19. The pole orientation measurement device according to claim 18, wherein said evaluation device is configured to:
determine auxiliary measured values from the measured values of said magnetic field sensors, the auxiliary measured values corresponding to measured values that would occur if the magnetic field sensors were separated by half the wavelength of the fundamental of the trackside stator magnetic field; and
determine the pole orientation angle by way of the auxiliary measured values thus formed.

20. The pole orientation measurement device according to claim 18, wherein said two magnetic field sensors are disposed in a common housing, and said housing is mounted in or on the rail vehicle.

21. The pole orientation measurement device according to claim 20, wherein said housing is mounted on a mount supporting at least one supporting magnet of the magnetic levitation vehicle.

22. The pole orientation measurement device according to claim 18, wherein:
the distance between said two magnetic field sensors corresponds to half the wavelength of the fundamental of the trackside stator magnetic field minus a difference distance; and
said evaluation device is configured to determine the pole orientation angle by way of a correction angle taking account of the difference distance and by way of the measured values of said two magnetic field sensors.

23. The pole orientation measurement device according to claim 22, wherein:
said evaluation device has an input connection configured to receive an input of a distance value indicating the distance between said two magnetic field sensors or the difference distance value; and
said evaluation device is configured to determine the correction angle from the distance value
or the difference distance value and the wavelength of the fundamental of the trackside stator.

24. The pole orientation measurement device according to claim 22, wherein said evaluation device has an input connection for entering the correction angle.

25. The pole orientation measurement device according to claim 19, wherein:
said evaluation device is configured to determine an auxiliary pole orientation angle by way of the auxiliary measured values as follows:
γ1=atan 2(H1/H2)
where γ1 is the auxiliary pole orientation angle, H1 and H2 are the auxiliary measured values; and
said evaluation device is configured to determine the pole orientation angle by way of the auxiliary pole orientation angle.

26. The pole orientation measurement device according to claim 19, wherein:
said evaluation device is configured to determine the auxiliary measured values by way of the measured values from said two magnetic field sensors, as follows:
$$H 1 = \frac{Sm \cdot cos ( β )}{{cos}^{2} ( β ) - {sin}^{2} ( β )} - \frac{Cm \cdot sin ( β )}{{cos}^{2} ( β ) - {sin}^{2} ( β )}$$
$$H 2 = \frac{Cm \cdot cos ( β )}{{cos}^{2} ( β ) - {sin}^{2} ( β )} - \frac{Sm \cdot sin ( β )}{{cos}^{2} ( β ) - {sin}^{2} ( β )}$$
where Sm and Cm are the measured values from the two measurement sensors, and β is the correction angle.

27. The pole orientation measurement device according to claim 22, wherein:
said evaluation device is configured to determine the correction angle as follows:
$$β = \frac{\frac{τ}{2} - A}{τ} \cdot \frac{π}{2}$$
where A is the distance value and τ is the wavelength of the fundamental of the trackside stator magnetic field.

28. The pole orientation measurement device according to claim 18, which comprises at least one active measurement coil disposed between said two magnetic field sensors in order to produce a magnetic field, and a detection device connected to said measurement coil and disposed to determine whether a stator slot or a stator tooth of the stator is located in an immediate vicinity of said measurement coil.

29. The pole orientation measurement device according to claim 28, wherein said detection device is disposed to carry out an incremental position measurement by counting down stator slots and/or stator teeth.

30. A method of measuring a pole orientation angle between a magnetic field of a trackside stator of a magnetic levitation railroad track and a magnetic reference axis of a magnetic levitation vehicle located on the magnetic levitation railroad track, the method which comprises:
providing two magnetic field sensors disposed at a spacing distance from one another less than half a wavelength of a fundamental of the magnetic field of the trackside stator;
measuring the magnetic field of the trackside stator with the magnetic field sensors; and
determining the pole orientation angle by way of the measured values from the two magnetic field sensors disposed apart by less than the wavelength of the fundamental of the trackside stator magnetic field.

31. The method according to claim 30, which further comprises:
forming auxiliary measured values by way of the measured values from the two magnetic field sensors, the auxiliary measured values corresponding to measured values that would occur if the magnetic field sensors were disposed at a spacing distance half the wavelength of the fundamental of the trackside stator magnetic field; and
determining the pole orientation angle form the auxiliary measured values.

32. The method according to claim 31, wherein the step of determining the auxiliary pole orientation angle by means of the auxiliary measured values comprises calculating the following:
γ1=atan 2(H1/H2)
where γ1 is the auxiliary pole orientation angle, and H1 and H2 are the auxiliary measured values.

33. The method according to claim 31, wherein the auxiliary measured values are determined by way of the measured values from the two magnetic field sensors as follows:
$$H 1 = \frac{Sm \cdot cos ( β )}{{cos}^{2} ( β ) - {sin}^{2} ( β )} - \frac{Cm \cdot sin ( β )}{{cos}^{2} ( β ) - {sin}^{2} ( β )}$$
$$H 2 = \frac{Cm \cdot cos ( β )}{{cos}^{2} ( β ) - {sin}^{2} ( β )} - \frac{Sm \cdot sin ( β )}{{cos}^{2} ( β ) - {sin}^{2} ( β )}$$
where Sm and Cm are the measured values from the two measurements sensors, and β is the correction angle.

34. The method according to claim 33, which comprises determining the correction angle as follows:
$$β = \frac{\frac{τ}{2} - A}{τ} \cdot \frac{π}{2}$$
where A is the distance value and τ is the wavelength of the fundamental of the trackside stator magnetic field.
